(19) United States
(12) Patent Application Publication
(10) Pub. No.: US 2004/0156137 A1
(43) Pub. Date: Aug. 12, 2004

(54) Timing variance write gate pull

(76) Inventors: Christopher Thomas Settje, Westminster, CO (US); Khalil B. Dizaji, Louisville, CO (US)

Correspondence Address: David K. Lucente, Seagate Technology LLC, Intellectual Property - COL2LGL, 389 Disc Drive, Longmont, CO, 80503, US

(21) Appl. No.: 10/409,821

(22) Filed: Apr. 9, 2003

Related U.S. Application Data
(60) Provisional application No. 60/445,585, filed on Feb. 6, 2003.

(51) Int. Cl. G11B 5/09; G11B 5/596

(52) U.S. Cl. 360/51; 360/77.04

(57) ABSTRACT

A method for determining the repeatable timing error in reclamped media is disclosed. The method allows the variation of the time intervals between servo sectors or other known locations on tracks on the disc to be determined and saved on the data storage device for later use in checking the timing during device operation. A second method for pulling write gate during data storage device operation based on known repeatable timing error data is also disclosed. This method checks the measured time intervals between sectors against an acceptable time interval range determined based on the known repeatable timing error for the disc.

### RELATED APPLICATIONS

This application claims priority of U.S. provisional application Serial No. 60/445,585, filed Feb. 6, 2003.

### FIELD OF THE INVENTION

This application relates generally to data storage devices and more particularly to a method for timing write operations in a rotating disc data storage device.

### BACKGROUND OF THE INVENTION

Data storage devices using rotating data storage discs write the initial servo track information including servo sectors and timing marks on their discs when they are manufactured as one of the last steps after they are assembled. In this process, timing marks and servo sectors are written with a fixed timing difference. That is, every so many milliseconds a new servo sector is written on a track. During operation, the data storage disc enables a “write gate” which is, essentially, a window that allows, writing of information to the disc. Based on the timing information, the write gate is disabled, or pulled, when the write head goes over the servo sector in order to protect the servo information from getting overwritten. With knowledge of the disc rotation speed, the write gate can be pulled and re-enabled at precise instances allowing the storage space between the servo sectors to be used efficiently.

However, for various reasons it is advantageous to write the server track information on the data storage discs prior to the discs' assembly in a data storage device. These discs are referred to as reclamped media because they are removed from the servo writer device and ‘reclamped’ into the data storage device. Using reclamped media results in several problems not normally encountered in the method of writing servo information after assembly.

One such problem is timing variations caused when the reclamped media is written with a first center of rotation but, because of imperfections introduced during assembly, operated in the data storage device about a different center of rotation. As any given track precesses about the data storage device's center of rotation, the linear or tangential velocity of the track will not be constant as it passes under a following write head. That is, the time between servo sectors as seen by the write head will vary depending on where the disc is in its rotation cycle.

In order to prevent overwriting of servo information, the write gate must be pulled at the shortest interval found in the cycle to accommodate the variation. In addition, the write gate cannot be re-enabled until the longest interval (plus the time it takes to traverse the servo sector) passes. This results in inefficient use of data storage space between the servo sectors as the write gate will be pulled earlier than necessary in some locations about the disc and will be held pulled longer than in necessary in some locations.

Accordingly, there is a need for a method that accounts for variations in timing about the data storage disc resulting from the disc rotating about a center other than the one the tracks were written with. The present invention provides a solution to this and other problems, and offers other advantages over the prior art.

### SUMMARY OF THE INVENTION

Against this backdrop the present invention has been developed. A method for determining the repeatable timing error in reclamped media is disclosed. The method allows the variation of the time intervals between servo sectors or other known locations on tracks on the disc to be determined and saved on the data storage device for later use in checking the timing during device operation. A second method for pulling write gate during data storage device operation based on known repeatable timing error data is also disclosed. This method checks the measured time intervals between sectors against an acceptable time interval range determined based on the known repeatable timing error for the disc.

The method for determining timing error in reclamped media involves measuring the time intervals between sectors of the reclamped media. The measured time intervals are then used to create repeatable timing error data that is then stored on the data storage device. The repeatable timing error data may take the form of a lookup table of measured time intervals, a measured time interval distribution, or as values defining a sinusoid or other representation of the measured time intervals. In addition, the time intervals may be measured multiple times and an average taken to limit the effect of random errors in the measurement process.

The second method, the method for pulling the write gate, involves measuring the time intervals between servo sectors during device operation. The measured time intervals are compared to an acceptable range to determine if the timing in the device is off. If the measured time interval is out of the acceptable range, then the write gate is pulled by the method to protect the data on the device from being overwritten. The acceptable range may be calculated from repeatable timing error data stored on the device or may simply be retrieved from a lookup table previously calculated from repeatable timing error data. These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive embodiment of a data storage device incorporating a preferred embodiment of the present invention showing the primary internal components.

FIG. 2 is a top view of a data storage disc illustrating data tracks and servo fields.

FIG. 3 shows an exemplary track on a reclamped data storage disc illustrating the difference between the track's manufactured center and its center of rotation as assembled in a data storage device.

FIG. 4 is a graph of the Repeatable Timing Error as a function of difference from a nominal address mark period (in ns) and servo sector.

FIG. 5 is a flowchart of one embodiment of a method for calibrating a data storage device to correct for Repeatable Timing Error in a data storage device.

FIG. 6 is a flowchart showing in greater detail the calibration step of FIG. 5.

FIG. 7 is a flowchart of one embodiment of a method for operating a data storage device to compensate for Repeatable Timing Error in reclamped rotating data storage media.

### DETAILED DESCRIPTION

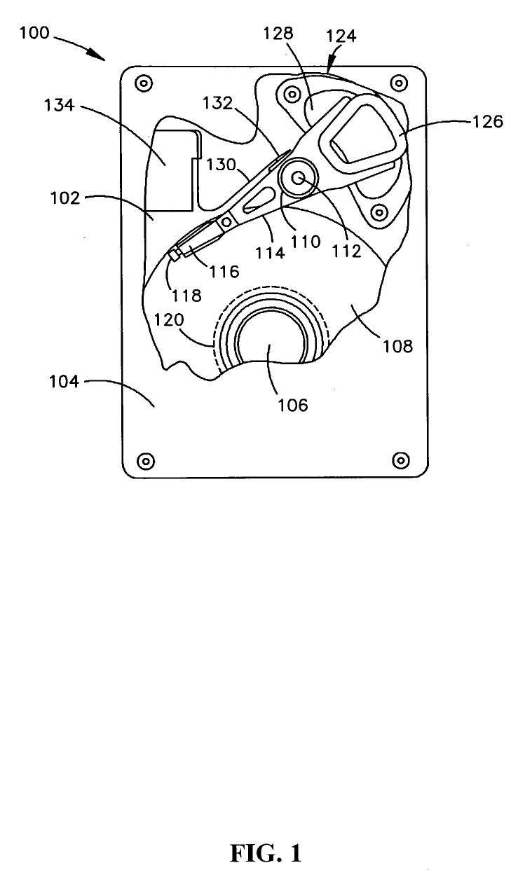

Embodiments of the present invention may be practiced in connection with data storage devices that utilize rotating data storage media, such as data storage discs. Examples of data storage devices include magnetic disc drives, also sometimes referred to as hard disc drives, having one or more rotating data storage discs, optical data storage devices utilizing optical discs, and data storage devices that utilize removable data storage media such as compact disc writers and digital video disc writers. One exemplary embodiment of a data storage device in accordance with the present invention, in this case a disc drive, is discussed in greater detail below with reference to FIG. 1. One skilled in the art will recognize that the methods and techniques of the present invention, even though often described with reference to the disc drive embodiment of FIG. 1, are easily adaptable to data storage devices in general.

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 that includes a fluid bearing slider enabling the head 118 to fly in close proximity above the corresponding surface of the associated disc 108.

During a seek operation, the track position of the heads 118 is controlled through the use of a voice coil motor (VCM) 124, which includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 may be de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 may include circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

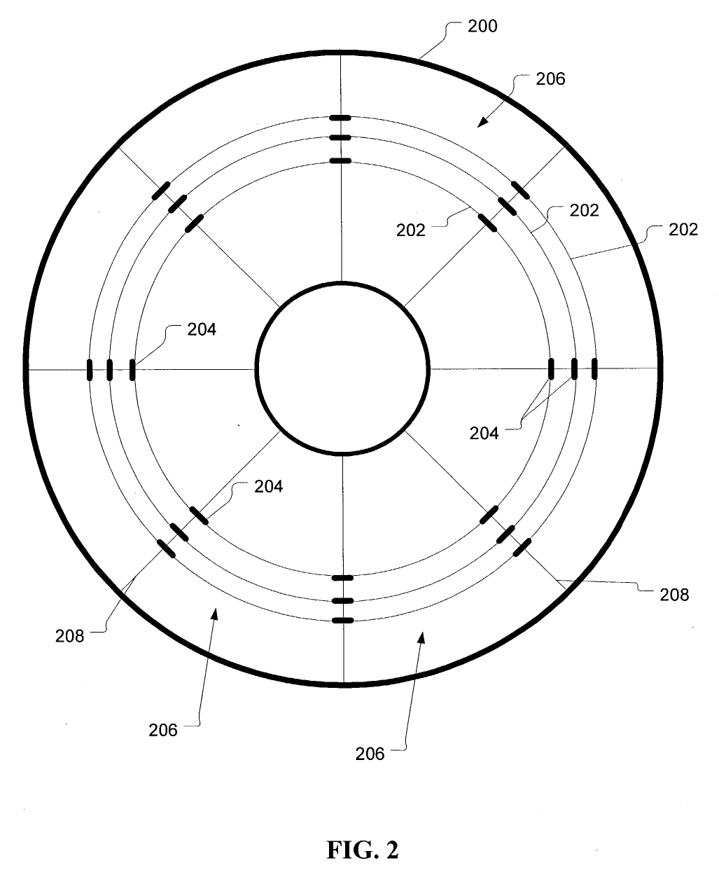

FIG. 2 shows a plan view of the surface of a disc 200 illustrating the positions of three data tracks 202 on the disc 200. In a magnetic disc drives as shown in FIG. 1, there can be as many as 100,000 tracks on the disc surface. The surface 200 is divided into sectors 206 by sector fields 204 written into each track 202. These servo fields, as they are written at a fixed time interval, may appear in radial lines 208 emanating from the center of rotation of the disc when they were written. The servo fields 204 include servo and other information for use by the data storage device. Such information can include the track number, the servo or sector number that identifies the location on the track 202, and an address or timing mark for use in checking the timing of the system.

A servo loop is provided in the data storage device to control a transducing head, in the case of magnetic disc drive, or some other reading head to follow a track 202 when reading and writing data. The servo loop monitors the registration of the track 202 by reading the servo fields 204 as they pass under the head and corrects for any variations in the track's path relative to the position of the head.

Servo fields are written in tracks on the surface of the disc when the data storage device is manufactured as part of the track writing process. The servo fields may be written by a multi-disc servo track writer or written by the data storage device as part of the initialization of the device. The servo fields are written with a fixed time interval between the servo fields sometimes referred to as a nominal time interval. That is, as the blank disc is rotated at a substantially constant angular velocity the servo fields are written sequentially with a fixed time between each writing of a servo field. In this way, there is equal number of servo fields on each track regardless of the radius of the track. If the tracks are written by the data storage device, this fixed time interval between servo tracks should remain constant as the tracks' relationship with the disc's center of rotation will not change.

One of the many data protection features provided in a rotating disc data storage device involves checking the timing of the device. This is accomplished by measuring the time interval between each servo field as the disc is rotated at its operating angular velocity. Often, this is done by measuring the time interval between address marks (AMs) within adjacent servo fields and the time intervals are referred to as AM to AM time intervals. Each measured AM to AM time interval is compared to a predetermined acceptable range of time intervals. If the disc is rotated at the same velocity that it was written at, this acceptable time interval range will be the same time interval used in the writing process plus or minus some predetermined time limit. If a measurement of AM to AM time interval is outside of the acceptable range, then the drive pulls the write gate and does not allow data to be written to the disc until subsequent AM to AM time interval measurements are within the acceptable range. In this way, the data storage device can immediately sense if there has been some shock or other occurrence that has affected the timing of the device. If this were not done, then existing data on the disc may be overwritten because of the timing error. The predetermined servo time limit is selected in order to maximize the use of available storage space while still providing sufficient protection against timing errors. If the time limit is too big, then usable storage space will be left unused, as the write gate will be pulled earlier than necessary. If the time limit is too small, then some timing errors may result in data being overwritten before the write gate is pulled.

Discs whose tracks are written ex situ, for example when the tracks are created by a multi-disc servo track writer and the disc is subsequently installed in a data storage device, will not maintain this fixed time interval between servo tracks because the exact center of rotation in the device will not exactly match that of the servo track writer. Such discs are referred to as being “reclamped” because they must be installed, e.g. physically reclamped to a second spindle. Because of imperfections in the reclamping process, a reclamped disc will not have the exact same relationship with the center of rotation within the data storage device as it did within the track writer.

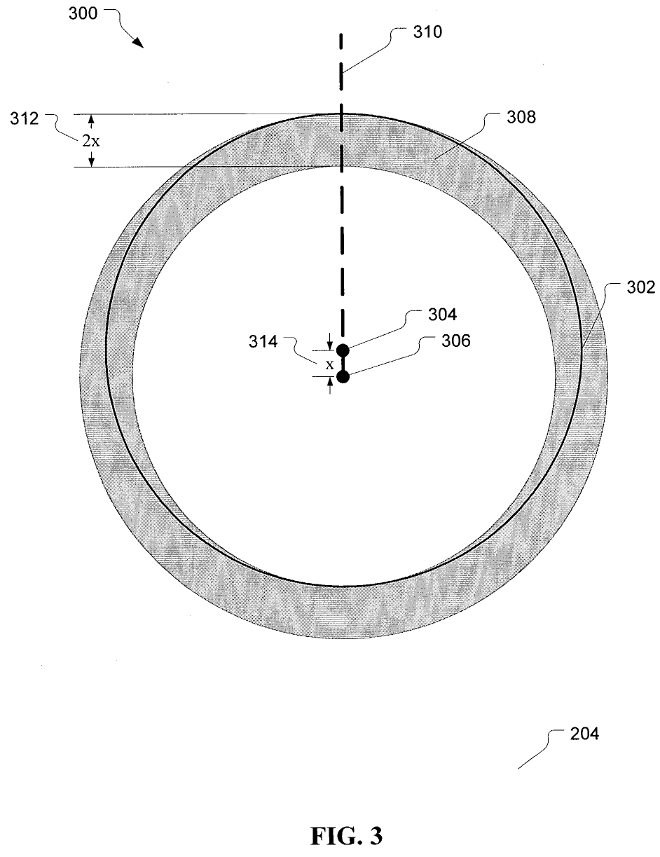

FIG. 3 shows the relationship between an exemplary track 302 on a reclamped data storage disc and the center of rotation 306 of the disc as installed in the data storage device. FIG. 3 illustrates the difference between the tracks' manufactured center 304 created when they were written and the actual center of rotation 306. FIG. 3 shows a top view of a surface 300 of a disc with an exemplary, perfectly circular track 302. The track 302 is provided with a number of servo fields (not shown) as discussed with reference to FIG. 2. The servo fields include address marks and servo information that identifies the track 302 and the location of the field on the track's circumference.

Because of the offset between the track's center 304 and the center of rotation 306, as the disc is rotated, the track 302 will precess about the actual center of rotation 306. This will make the track 302 appear to oscillate, relative to the center of rotation 306, within the region 308 indicated by the dashed circles shown. At a fixed radial 310 relative to the center of rotation 306, the track 302 will oscillate over a distance 312 twice that of the distance 314 between the track's center 304 and the center of rotation 306. If the disc is rotating at a constant velocity, this precession about the center of rotation 306 will make the tangential velocity of the track vary along the track's circumference. The portion of the track farthest from the center of rotation 306 will appear to be traveling relatively slower than the rest of the track 302 as it passes under a write head located at the fixed radial position 310. Likewise, the portion of the track closest to the center of rotation 306 will appear to be traveling relatively faster than the rest of the track 302 as it passes under a write head located at the fixed radial position 310.

A head attempting to write to the track 302 will follow the track as it oscillates within the region 308. However, the head will encounter varying time intervals between adjacent AMs depending on where the AMs are located about the track's circumference. This timing variation is referred to as Repeatable Timing Error (RTE) as it is often discussed in terms of variations from a nominal AM to AM time interval. The nominal AM to AM time interval can be defined as that used when the servo fields for the tracks were written. However, this is not necessary and in alternative embodiments any nominal interval may be used.

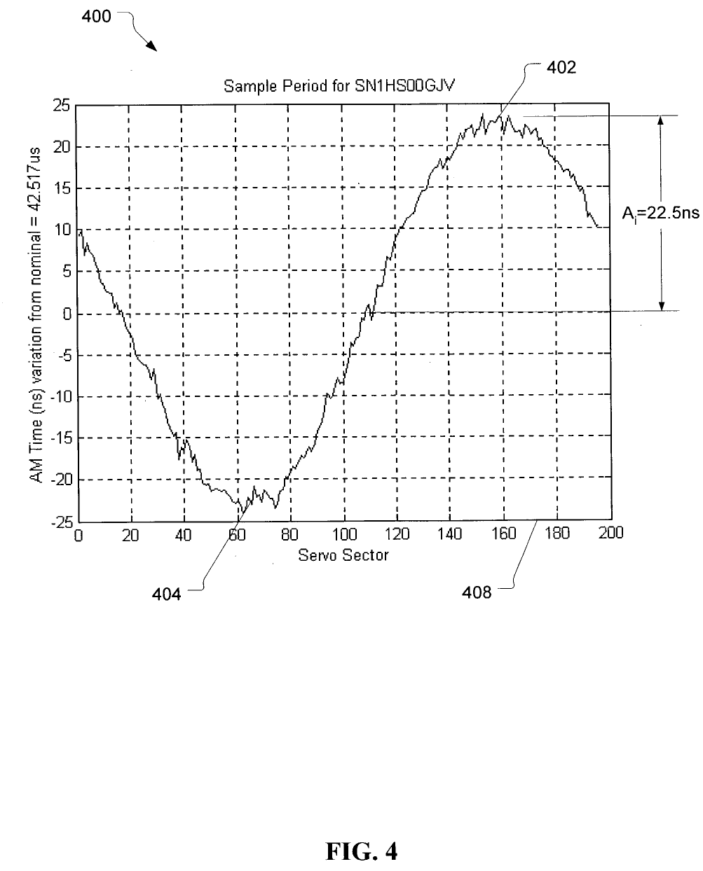

FIG. 4 is an exemplary graph 400 of the RTE over the circumference of an exemplary track i. The RTE is presented as a difference between the measured AM to AM time interval from a nominal AM to AM time interval in nanoseconds (ns) and is determined by the equation:

RTE_{k,i}=T_{k, i}−Tₙₒₘᵢₙₐₗ

where RTEₖ is the Repeatable Timing Error for sector k on a track i, Tₙₒₘᵢₙₐₗ is a predetermined nominal AM to AM time interval, and Tₖ is the measured AM to AM time interval at circumferential position k on the track i. Note that Tₖ may be a single measurement from one revolution of the track i or may be an average or some other representative value derived from multiple measurements of the same time interval. In the embodiment shown, the variable k is the actual servo sector number derived from the servo fields on the track i, which is also the ordinate 408 of the graph 400.

As one would expect, the graph 400 shows a sinusoidal variation of time as the track precesses about the center of rotation during a complete revolution. There is a recognizable sinusoidal peak 402 and trough 404, corresponding to a maximum RTE and a minimum RTE, respectively. The RTE amplitude 406 of the sinusoid shown is approximately 22.5 ns indicating a 45 ns total variation between the AM to AM time at different circumferential locations about the track i. In FIG. 4, the peak occurs at a location k^{˜} servo sector 158.

It should be noted that the amplitude of RTE will vary over the tracks on a data storage disc as an inverse of the radius of the tracks. Therefore, the tracks closest to the center of rotation will elicit the highest amplitudes of RTE.

As can be seen from FIG. 4, there is a significant variation in the AM to AM time interval over a revolution of the data storage disc. This causes a problem when using another method of protecting against timing errors during drive operation. The other method for checking the timing and pulling write gate in response to detected timing errors uses a fixed acceptable timing interval range. In practice, the RTE amplitude 406, especially at the inner diameter of the disc, is significantly larger than the predetermined servo time limit (STL) used to calculate the acceptable range in devices. For example, an STL=0.1% of the spin speed or 42 ns is indicative of the type of drive tested to produce the data in the graph 400. If the timing check and write gate pull protection method is used for reclamped media, the acceptable timing interval range would have to be at least twice the RTE amplitude 406 just to account for the RTE variation. Such an interval range is unacceptable as it would result in the write gate being pulled more often than necessary which results in inefficient non-use of storage space on the disc that would otherwise be available if the correct time interval for that sector were known.

In order to efficiently use the available data storage space on the disc, it is desirable to adjust the acceptable time interval range based on the RTE. In embodiments of the present invention, the RTE of a disc is determined during initial calibration of the data storage device. The calibration may occur during manufacture or at the first use of the device. In one embodiment, the RTE of the drive is determined as one of the final stages of manufacture of the data storage device and the RTE data that is generated by the calibration is stored in a historical database maintained by the manufacturer.

As part of the calibration process RTE data is generated and stored in the data storage device. It may be stored on a data storage disc in the device or in some other non-volatile storage provided with the device. The RTE data is stored along with other device data on a data storage disc in the device. Upon startup of the device, the stored RTE data may be retrieved and read into memory for faster access by the control circuitry of the device.

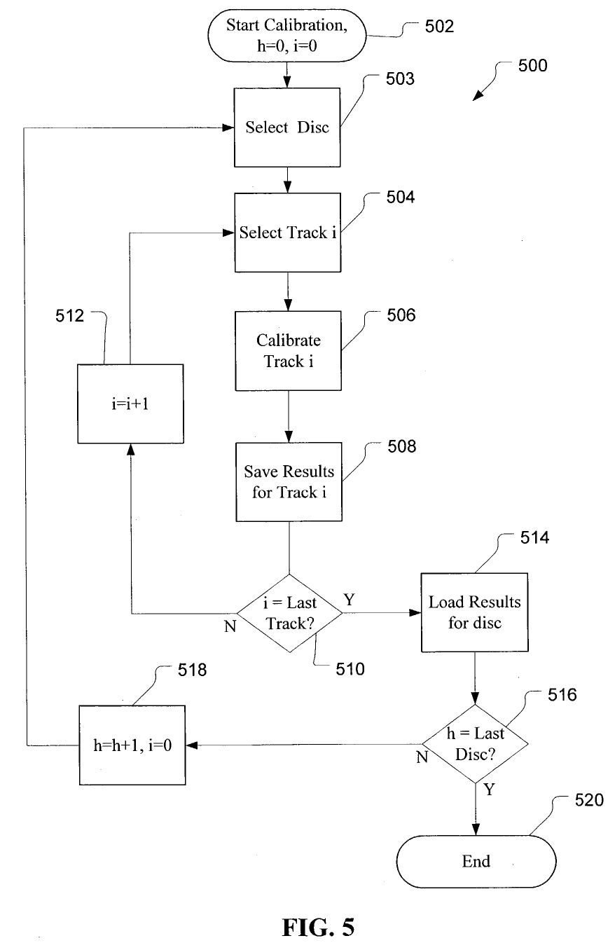

FIG. 5 is a general flowchart of one embodiment of a method 500 for calibrating a data storage device to correct for RTE in a data storage device. The calibration method 500 starts with an initiation operation 502 which may include spinning the disc up to operating speed. The operation may also include setting a track variable to some initial track number. In the embodiment shown the initiation operation sets the track variable i to 0. This operation 502 may also, as in the embodiment shown, set a disc variable h to an initial value of 0.

After the initiation operation 502, control passes to a first select operation 503 that selects a disc to read from. Control then passes to a second select operation 504 that moves the read head or other reading device to track i.

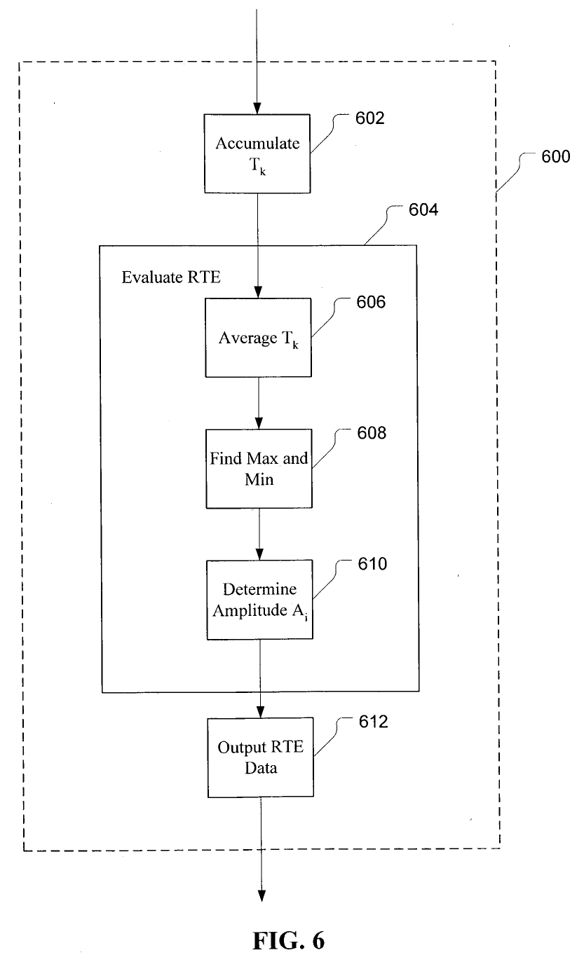

Next, calibrate operation 506 determines the RTE for the track i. This operation includes measuring the AM to AM time interval between at least some servo fields, and generating RTE data for use by the device when performing its timing checks in future operation. Generation of the RTE data may include substantial analysis of the measured AM to AM time interval data. The RTE data stored may be raw data such as the AM to AM time intervals for each sector, or may be analyzed data representative of the RTE of the track. For example, in one embodiment, an amplitude and a servo sector number are stored as the RTE data. By assuming the RTE is a sinusoid with one period over the track, the amplitude and identification of one known point on the sinusoid is sufficient to reproduce the sinusoidal RTE distribution for the entire track. The calibrate operation 506, including how the RTE data is generated and stored, is discussed in greater detail with reference to FIG. 6.

Once the RTE data has been generated, storing operation 508 saves the data for track i. In the embodiment shown, as each track is calibrated, the data is saved to a temporary storage location, such as a buffer, that may or may not be in the device. In an alternative embodiment, the data may be written directly to a permanent storage location on the device in this operation.

After the calibration of track i is completed, determination operation 510 determines if there are any additional tracks to be calculated. In the embodiment shown, this is accomplished by comparing the track variable i to some predefined number of tracks. If track i is not the last track to be calibrated the track variable is incremented in increment operation 512 and control is passed back to the select track operation 504. Thus, the calibration method 500 repeats the track calibration sequence until all tracks that are to be calibrated are calibrated.

Alternative embodiments use other methods for ensuring that all the appropriate tracks are calibrated. Note that not all tracks need to be calibrated. In one embodiment, six tracks are selected from all the tracks on the disc and the method 500 performs the calibration operation 506 sequentially on each of the six until all have been calibrated. To select these tracks, the disc is divided into seven zones of an equal number of tracks and the six tracks comprising the border between zones are calibrated. Any number of tracks may be calibrated depending on how accurate the RTE information needs to be. In addition, depending on the method of representing the RTE data, e.g. as a lookup table or as a curve fitted function, it may not be helpful to calibrate more than a certain number of tracks.

If the track i is the last track to calibrated on the disc, control passes to a loading operation 514 that takes the RTE data for the disc in the temporary storage location and stores it to its permanent location on one of the discs in the data storage device. The loading operation 514 may include analysis of the RTE data and storing of a second set of RTE data derived from the first. For example, if an embodiment uses a function to describe the RTE for the disc, rather than a lookup table, the function may be calculated from the RTE data in this operation and saved to the data storage device. In the embodiment shown, loading operation 514 stores the track number, amplitude, and servo sector number for each calibrated track into a lookup table.

After loading operation 514, a second determination operation 516 determines if all of the discs in the device have been calibrated. In the embodiment shown the disc variable h is compared to the number of discs in the device. If more discs remain, then increment operation 518 increments the disc variable h, resets the track variable i, and control is passed back to select disc operation 503. Thus, the calibration method 500 repeats the disc calibration sequence until all discs in the data storage device are calibrated. If the second determination operation 516 determines that all discs have been calibrated, then the method ends with an termination operation 520. In end operation 520, various housekeeping activities may be performed including clearing the temporary storage locations and updating the file system to reflect the RTE now stored in the data storage device.

The method 500 is but one possible flow for calibrating the discs on a data storage device. Many variations on this flow are possible that also achieve the end result of determining the RTE for the discs in the device. For example, one variation would be to perform the loading operation 514 last, after all the RTE data for each disc has been generated and stored in temporary memory.

FIG. 6 is a flowchart showing in greater detail one embodiment 600 of the flow within calibration operation 504 of FIG. 5. The first operation shown is an accumulation operation 602. In the accumulation operation 602, the AM to AM time intervals Tₖ are measured and accumulated for each sector k. In other words, multiple AM to AM time interval measurements may be made for each sector. In one embodiment, a predetermined number of measurements are made for each sector and each measurement is stored in a temporary storage location on the data storage device. Note that there are many alternative ways of measuring time intervals to obtain an RTE distribution for a track. For example, the time intervals for only selected sectors on a track may be measured rather than measuring the intervals for all sectors. Alternatively, multiple sector time intervals may be measured rather than sector time intervals. Any such method for obtaining an RTE distribution is considered within the scope of this invention.

After the measured time intervals have been accumulated, control passes to an evaluation operation 604. In the embodiment shown, evaluation operation 604 analyzes the measured time intervals accumulated in the accumulation operation and, ultimately, generates RTE data that will be used by the data storage device during operation. Three sub-operations are shown within the evaluation operation as an example of how the measured time intervals may be analyzed.

Starting with the multiple measurements for each AM to AM time interval, the averaging sub-operation 606 calculates an average AM to AM time interval for each sector. The average time intervals are then inspected in a find maximum and minimum sub-operation 608. In the embodiment, the find sub-operation 608 determines the value of maximum time interval (in ns), its location (as a sector number) and the minimum value (in ns). Finding the maximum and minimum values and peak locations may require significant calculation as there may not be well defined peaks or the data may not be a perfect sinusoid. In that case, they may be estimated using curve fitting techniques or some other method. Such methods for analyzing sinusoidal data are well known in the art and any are usable here. For example, in one embodiment, the maximum is determined by finding a zero crossing preceding the maximum and adding the equivalent of 90 degrees (one quarter of the number of sectors on the track) to the zero crossing location.

After the maximum and minimum values are found, amplitude sub-operation 610 calculates and amplitude for the sinusoidal variation of the measured time intervals by subtracting the minimum time interval value from the maximum time interval value and dividing the result by 2. After this sub-operation, output results operation 612 outputs the amplitude calculated by the amplitude sub-operation 610 and the maximum location calculated by the find max and min sub-operation 608. In the embodiment shown, these two values are the results output by the calibration operation 506 to the storing operation 508.

In one embodiment, six tracks on two disc surfaces were analyzed with the calibration method and repeatable error data was generated. The data was fit to a sinusoid distribution and stored on the data storage device as follows:

Disk 00

RTE Amplitude=0002 servo clocks. Sector=0032h. Trk/2=B2B3h.

RTE Amplitude=0002 servo clocks. Sector=0032h. Trk/2=8EF8h.

RTE Amplitude=0002 servo clocks. Sector=001Fh. Trk/2=6B3Dh.

RTE Amplitude=0001 servo clocks. Sector=001Fh. Trk/2=4782h.

RTE Amplitude=0001 servo clocks. Sector=001Fh. Trk/2=23C7h.

RTE Amplitude=0001 servo clocks. Sector=001Fh. Trk/2=000Ch.

Disk 01

RTE Amplitude=0003 servo clocks. Sector=0062h. Trk/2=B2B3h.

RTE Amplitude=0003 servo clocks. Sector=0062h. Trk/2=8EF8h.

RTE Amplitude=0002 servo clocks. Sector=005Fh. Trk/2=6B3Dh.

RTE Amplitude=0002 servo clocks. Sector=004Fh. Trk/2=4782h.

RTE Amplitude=0001 servo clocks. Sector=004Fh. Trk/2=23C7h.

RTE Amplitude=0001 servo clocks. Sector=004Fh. Trk/2=000Ch.

In the exemplary data above, the disc number identifies the disc, the RTE Amplitude gives the amplitude measured in servo clocks, the Sector identifies the sector, and the Trk/2 identifies the track.

The embodiment described above illustrates one method to characterize the RTE data, namely as a perfect sinusoid defined by an amplitude and a maximum peak location with a period being the length of the track. The method above could be easily modified to generate the values appropriate for any other specific representation of a sinusoid, such as representing the amplitude as a proportion of some known value such as the nominal time interval and representing the phase as the minimum location or a phase shift from some fixed point on the track (e.g. sector 0). In addition, the RTE may be characterized without requiring it to be a perfect sinusoid, such as via a lookup table. Possibly the most accurate characterization is in a lookup table containing the average AM to AM time intervals for each sector. However, this would require a significant amount of storage space. One skilled in the art will recognize that there are many different methods to measure, analyze and represent the RTE data and that they are all within the scope of the invention as long as the data storage device is capable of using the data that is output to determine an acceptable time interval range that takes into account the RTE.

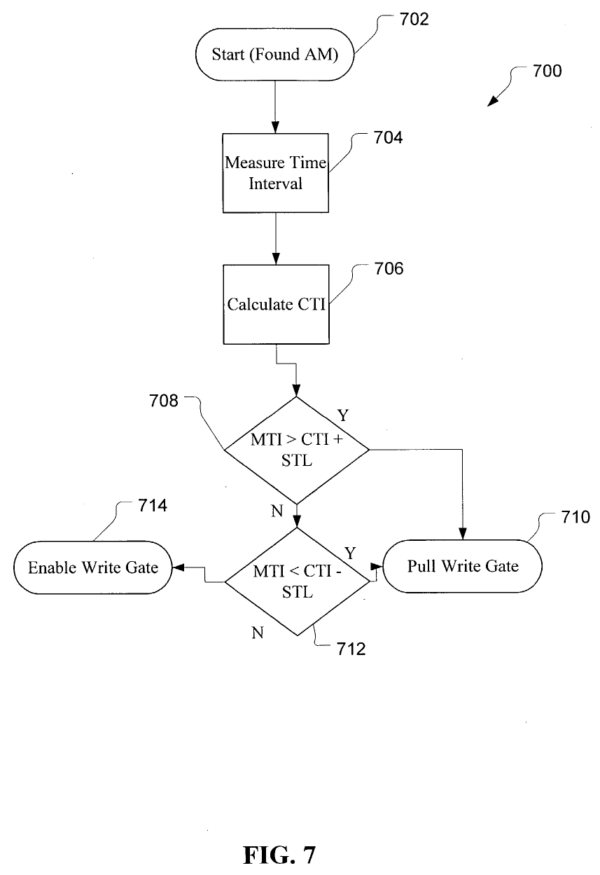

FIG. 7 is a flowchart of one embodiment of a method 700 for operating a data storage device to compensate for RTE when performing a timing check. The data storage device in the method 700 has RTE data generated by a calibration method and stored somewhere on the data storage device. In the embodiment shown in FIG. 7, the data storage device includes RTE data stored by the method 500 which was performed during the data storage device's manufacture.

The method 700 starts with an initiation operation 702 when an AM is detected during the data storage device's operation. In a magnetic disc drive embodiment, the read head as it follows a track will detect the AM as a servo field passes under the head. In an embodiment wherein the data storage device utilizes optical media, the address mark, or its optical equivalent, may be detected by an optical reader. As part of the initiation operation 702, the time that the AM is detected, the current track being read, and the sector number from the servo field containing the AM are noted and saved in a temporary storage location, in this embodiment a buffer. Note that the buffer also contains at least the last prior AM detection time.

After an AM is detected in the initiation operation 702, a time interval measurement operation 704 subtracts the AM detection time noted in the initiation operation 702 from the last AM detection time already in the buffer to calculate a measured time interval for the sector between the two AMs. This measured AM to AM time interval (MTI) is then saved in a temporary storage location or otherwise noted for use later in the method 700.

Control then passes to a corrected time interval (CTI) calculation operation 706 wherein a CTI for the sector number of the detected AM is calculated using RTE data stored in permanent memory on the disc and the sector number. Depending on the format of the RTE data, this may be a simple or a highly complex calculation. For example, if the RTE data is in the form of a lookup table containing CTIs for each location on every track, the CTI can be simply read from the table. Alternatively, in the embodiment shown, representative RTE data for six tracks are stored on the data storage device. Depending on the track number, RTE data for one of the six tracks is retrieved. This track RTE data is then used as the RTE data for the track being currently read. Note that in alternative embodiments some calculation may be used to adjust the RTE data based on the measured track's position relative to the six tracks for which the RTE is available. The sector location of the detected AM is then used to determine where on the sinusoid the sector is and, thus, what the corrected time interval is. An exemplary equation for this calculation is:

$$CTI = NTI + {A}_{i} sin ( {360}^{°} ( \frac{{S}_{AM} - ( {S}_{max} - 0.25 {S}_{total} )}{{S}_{total}} ) )$$

where CTI is the corrected time interval in ns, NTI is the nominal time interval in ns, Aᵢ is the amplitude for track i read from the RTE data in ns, S_{AM} is the sector number of the AM detected in the initiation step 702, Sₘₐₓ is the sector number of the maximum time interval as retrieved from the RTE data for track i, and Sₜₒₜₐₗ is the total number of sectors on the track. In the calculation above, the nominal time interval and Sₜₒₜₐₗ are constants for all tracks on the data storage device. As constants, they may be recorded with the RTE data or elsewhere and retrieved as part of the calculation or included in the calculation software as constants.

Now that the CTI for the sector has been calculated based on the stored RTE data, control passes to a first determination operation 708 that determines if the MTI is greater that an upper limit of the acceptable range of time intervals. The upper limit is determined by adding an error value, called the servo timing limit (STL), to the CTI. The STL is a predetermined error threshold that can be provided when the drive is manufactured. The STL may be a variable stored on the data storage device or may be included as part of the calculation software.

If the first determination operation 708 determines that the MTI is greater than the upper limit, the MTI is outside of the acceptable range and control is passed to a pull write gate operation 710 that pulls the write gate, i.e. inhibits the data storage device from writing to the track and then terminates the method 700. In one embodiment, pulling the write gate is accomplished by conducting a logical ‘0’ or low logic signal to an AND gate that controls the writing process. This logic signal remains at 0 until it is changed to a one by the enable write gate operation 714 discussed below. Thus, at the least the write gate stays pulled until the next AM is detected at which time the method 700 is repeated for the new sector.

If the first determination operation 708 determines that the MTI is less than the upper limit of CTI+STL, then control is passed to a second determination operation 712. The second determination operation 712 similarly determines if the MTI is greater than the lower limit of the acceptable range by determining if the MTI is less than CTI−STL. If the second determination operation 712 determines that the MTI is less than the lower limit, the MTI is outside of the acceptable range and control is passed to the pull write gate operation 710 that pulls the write gate as described above.

If the second determination operation 712 determines that the MTI is greater than the lower limit of the acceptable time interval range, then the MTI is within the acceptable range and the method ends with an enable write gate operation 714. In the embodiment, the enable write gate operation 714 causes a logical high to be conducted to the AND gate controlling the writing in the data storage device, thus enabling the data storage device to write in the sector.

Note that the under the method 700 write gate will be pulled when there is some timing error that causes the MTI to be outside of the acceptable time interval range. Thus, the method 700 constitutes a sector by sector timing check during drive operation. Additionally, the method 700 is a method for pulling write gate that is corrected for the RTE inherent in the use of reclamped media. Therefore the method allows the write gate to be pulled with a greater accuracy than previous methods.

One skilled in the art will immediately recognize that there a number of variations of the method 700 that would function equivalently. For example, rather than having an enable write gate operation 714, the write gate could be enabled as part of the initiation operation 702. Another example is replacing the two determination operations with a single determination operation that determines if the MTI is within the acceptable range defined by CTI±STL. Such variations are functional equivalents of the method 700 and considered within the scope of the present invention.

In summary, embodiments of the present invention may be viewed as a method for determining repeatable timing error data in a data storage device having a rotating data storage disc with a plurality of specified locations on a first track. The method includes measuring a time interval between two of the plurality of specified locations on the rotating data storage disc. The measuring step may then be repeated a predetermined number of times to generate an average time interval between locations. The method also evaluates the variation in the measured timing intervals to generate repeatable timing error data.

The present invention may also be viewed as a method for pulling write gate in a data storage device. The method includes measuring a time interval between a first timing mark on a track at a first location and a second timing mark on the track at a second location on a first rotating data storage disc. The method also compares the measured time interval to an acceptable interval range determined from repeatable timing error data, the track, the first location and a predetermined timing limit. The method pulls the write gate if the measured time interval is not within the acceptable interval range.

The present invention may also be viewed as computer readable media having computer executable instructions for performing the methods described above.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the calibration methods were discussed in the manufacturing context as being performed when the data storage device is assembled. However, in an alternative embodiment, the calibration method may be performed periodically by the drive to correct for slippage in the data storage discs that might occur during the life of the data storage device. Another alternative embodiment is the use of the methods described above for removable rotating storage media such as recordable compact discs, recordable digital video discs and the like. Removable media are reclamped every time they are reinserted in a reading device and will inherently have RTE. As long as RTE data provided on the medium is usable by the device, then a method such as that shown in FIG. 7 for pulling write gate in response to timing errors will be effective in increasing the efficiency of data storage on the medium. Numerous other changes may be made which will readily suggest themselves to those skilled in the art and which are encompassed in the scope of the invention disclosed and as defined in the appended claims.

What is claimed is:

1. A method comprising:
measuring a time interval between two of a plurality of specified locations on a storage medium;
repeating the measuring step a predetermined number of times; and
evaluating a variation in the measured timing intervals to generate repeatable timing error data.

2. The method of claim 1, further comprising:
writing at least a portion of the plurality of specified locations on the storage medium prior to installing the storage medium in a data storage device; and
installing the storage medium in the data storage device.

3. The method of claim 1, further comprising:
determining a variation between the plurality of time intervals as a function of the specified locations on the storage medium.

4. The method of claim 1, wherein the evaluating step comprises:
calculating an average time interval between each of the plurality of specified locations on the storage medium; and
identifying a maximum average time interval, a specified location associated with the maximum average time interval, and a minimum average time interval.

5. The method of claim 4, wherein the evaluating step further comprises:
determining an amplitude of time interval variation between the specified locations based on the minimum average time interval and the maximum average time interval.

6. The method of claim 1 further comprising:
repeating the method of claim 1 for a predetermined set of tracks on the storage medium.

7. The method of claim 1, wherein the specified locations include address marks in servo fields on the first track, adjacent servo fields defining sectors on the storage medium, wherein the measuring step comprises
measuring a time interval associated with each sector by measuring a time interval between each set of adjacent address marks on the first track with a transducing head following the first track;
and the evaluation step comprises,
determining a variation of the time intervals over the sectors on the first track,
calculating an average time interval associated with each sector on the first track;
identifying a maximum average time interval, a sector associated with the maximum average time interval, and a minimum average time interval; and
determining an amplitude of time interval variation over the sectors on the first track based on the minimum average time interval and the maximum average time interval.

8. A data storage device comprising:
a storage medium having a plurality of specified locations;
a write gate pull module that compensates for variations in timing intervals between specified locations.

9. The data storage device of claim 8, wherein the specified locations are sectors on tracks that are created prior to installing the storage medium in the data storage device.

10. The data storage device of claim 8, wherein the data storage device further comprises calibration data relating to the variations in timing intervals between specified locations.

11. The data storage device of claim 8, wherein the storage medium is a rotating data storage disc.

12. The data storage device of claim 10, wherein the calibration data includes a first specified location and a measured amplitude of the variations in timing intervals for specified locations.

13. The data storage device of claim 10, wherein the write gate pull module pulls write gate based on the calibration data.

14. A method for pulling write gate in a data storage device comprising:
measuring a time interval between a first timing mark on a track at a first location and a second timing mark on the track at a second location on a first rotating data storage disc;
comparing the measured time interval to an acceptable interval range determined from repeatable timing error data, the track, the first location and a predetermined timing limit; and
pulling write gate if the measured time interval is not within the acceptable interval range.

15. The method of claim 14, wherein the data storage device includes a plurality of rotating data storage discs, the comparing step further comprising:
comparing the measured time interval to an acceptable interval range determined from repeatable timing error data, the first rotating storage disc, the track, the first location and a predetermined timing limit.

16. The method of claim 14, wherein the comparing step further comprises:
retrieving, from a lookup table, a corrected timing interval associated with the track and the first location;
defining the acceptable interval range as being within the predetermined timing limit of the corrected timing interval.

17. The method of claim 14, wherein the comparing step further comprises:
retrieving the acceptable interval range from a lookup table.

18. The method of claim 14, wherein the comparing step further comprises:
retrieving repeatable timing error data associated with the track; and
calculating the acceptable interval range based on the first location, the retrieved repeatable timing error data and a predetermined timing limit.

19. The method of claim 14, wherein the retrieving step comprises:
retrieving an amplitude and a sector identifier associated with the track.

20. The method of claim 19, wherein the calculating step comprises:
determining a phase relationship between the first location and the sector identifier;
modifying the amplitude based on the phase relationship to create a modified amplitude;
calculating a corrected timing interval based on the modified amplitude and a nominal time interval; and
calculating the acceptable interval range based on the corrected timing interval and a predetermined servo limit value.
